(19) United States
(12) Patent Application Publication
(10) Pub. No.: US 2007/0079319 A1
(43) Pub. Date: Apr. 5, 2007

(54) Recording medium cartridge

(75) Inventor: Kiichiro Kitagawa, Kanagawa (JP)

Correspondence Address: SUGHRUE-265550, 2100 PENNSYLVANIA AVE. NW, WASHINGTON, DC, 20037-3213, US

(73) Assignee: FUJI PHOTO FILM CO., LTD.

(21) Appl. No.: 11/529,430

(22) Filed: Sep. 29, 2006

(30) Foreign Application Priority Data
Sep. 30, 2005 (JP) P.2005-289002

(51) Int. Cl. G11B 23/03

(52) U.S. Cl. 720/725

(57) ABSTRACT

A recording medium cartridge includes: a photosensitive recording medium; a main body including: a fist opening portion exposing a center and a recording surface of the photosensitive recording medium to an exterior of the main body, the main body rotatably receiving the photosensitive recording medium; a light-shielding plate including: a second opening portion opposed to the first opening portion, the light-shielding plate being attached to the outer side of the main body; a shutter incorporated between the main body and the light-shielding plate, having an external size greater than the first opening portion and the second opening portion, and the shutter being movable between a closed position and an opened position within the range of the light-shielding plate; and a single locking member retaining the shutter at the closed position and allowing the shutter to open from the closed position.

### BACKGROUND OF THE INVENTION

1. Field of the Invention

The invention relates to a photosensitive recording medium cartridge for receiving a photosensitive recording medium and more particularly to a photosensitive recording medium cartridge comprising a shutter for opening and closing an opening portion provided in a cartridge main body.

2. Background Art

As a related art photosensitive recording medium there has been known a hologram recording medium allowing hologram data recording received in a cartridge analogous to cartridge for DVD-RAM (see, e.g., JP-A-2004-029476 (the term “JP-A” as used herein means an “unexamined published Japanese patent application”)). Such a hologram recording medium is a photosensitive recording medium comprising a hologram recording layer made of a photosensitive material laminated on a disc-shaped support. This hologram recording medium allows multi-layer recording of data as interference band of laser beam and thus can be provided with a greater data recording capacity than DVD, which is a present popular recording medium. When the hologram recording medium is subjected to exposure of the hologram recording layer or attachment of dust to the hologram recording layer, its properties can be adversely affected. Therefore, the cartridge for hologram recording medium needs to have light-shielding properties and dust-proofness. Such a photosensitive recording medium cartridge has a shutter for opening and closing the opening portion provided in the cartridge main body and thus is disadvantageous in that it needs a complicated mechanism for opening and closing the shutter, adding to cost.

### SUMMARY OF THE INVENTION

The invention has been worked out in the light of the aforementioned problems. An object of the invention is to provide a photosensitive recording medium cartridge comprising a shutter opening/closing mechanism which is simplified so as to reduce the number of required parts and hence enhance the productivity.

The object of the invention can be accomplished by the following constitutions.

(1) According to an aspect of the invention, a recording medium cartridge comprising: a photosensitive recording medium having a discoid shape; a main body comprising: a fist opening portion exposing a center and a recording surface of the photosensitive recording medium to an exterior of the main body, the main body rotatably receiving the photosensitive recording medium; a light-shielding plate comprising: a second opening portion opposed to the first opening portion, and exposing the center and the recording surface of the photosensitive recording medium to the exterior of the main body, the light-shielding plate being attached to the outer side of the main body; a shutter incorporated between the main body and the light-shielding plate, having an external size greater than the first opening portion and the second-opening portion, and the shutter being movable between a closed position and an opened position within the range of the light-shielding plate; and a single locking member retaining the shutter at the closed position and allowing the shutter to open from the closed position.

(2) The recording medium cartridge as described in the item (1), which comprises: a sliding member having a longitudinal portion connected to the shutter, the longitudinal portion extending close to the edge portion of the main body along the moving direction of the shutter, the sliding member being engaged with the locking member disposed apart from the opening portion at the closed position of the shutter, and being released from the locking member by opening operation.

Thus, the locking mechanism comprises a single locking member for allowing the shutter disposed between the first opening portion and the second opening portion to open from the closed position. In this arrangement, the number of parts constituting the locking mechanism can be reduced, making it possible to reduce the number of steps required for parts control and giving advantage in cost saving.

(3) The recording medium cartridge as described in the item (1) or (2), wherein the main body has been subjected to one of matting and embossing on an inner surface of the main body opposed to the photosensitive recording medium and an outer surface of the main body opposed to the shutter so that the inner surface and the outer surface of the main body have a surface roughness of from 5 μm to 20 μm.

In this arrangement, even when light beam enters in the interior of the cartridge or the gap between the cartridge main body and the shutter, the light beam can be diffused or attenuated by the rough surface, making it possible to eliminate the effect on the photosensitive recording medium.

(4) The recording medium cartridge as described in any one of the items (1) to (3), wherein the main body comprises: a first shell having a sheet shape; and a second shell welded to the first shell in an arrangement superposed on the first shell, the first shell and the second shell comprise same or analogous thermoplastic plastic each other, and other parts including the shutter comprise a material different from the thermoplastic plastic of the first shell and the second shell.

In this arrangement, he welding of the first shell and the second shell to the other parts can be prevented during the welding of the first shell and the second shell to each other.

(5) The recording medium cartridge as described in any one of the items (1) to (4), wherein the first shell, the second shell and the shutter comprise a plastic containing a light-shielding material 0.01% to 5.00% by weight.

(6) The recording medium cartridge as described in any one of the items (1) to (5), wherein the first shell, the second shell and the shutter comprise a plastic containing a carbon black of 0.01% to 2.00% by weight.

In this arrangement, the light transmittance of the cartridge main body and the shutter can be reduced, making it possible to enhance the light shielding properties of the cartridge.

(7) The recording medium cartridge as described in any one of the items (1) to (6), wherein the first shell, the second shell and the shutter comprise a plastic containing a silicone-based lubricant of 0.1% to 5.0% by weight.

In this arrangement, the shutter can operate smoothly, making it possible to prevent the generation of shavings, etc. due to the friction of the shutter with the cartridge main body.

(8) The recording medium cartridge as described in any one of the items (1) to (7), wherein the photosensitive recording medium is a hologram recording medium.

In this arrangement, the hologram recording medium can be carried without being exposed to light and thus can be utilized in recording devices which are installed at different places.

The invention can provide a photosensitive recording medium cartridge comprising a shutter opening/closing mechanism which is simplified so as to reduce the number of required parts and hence enhance the productivity.

### BRIEF DESCRIPTION OF THE DRAWINGS

The invention disclosed herein will be understood better with reference to the following drawings of which:

FIG. 1 is an external perspective view of a photosensitive recording medium cartridge according to an embodiment of implementation or the invention with one surface thereof upside;

FIG. 2 is an external perspective view of the photosensitive recording medium cartridge shown in FIG. 1 with the upper surface thereof down;

FIG. 3 is an exploded perspective view illustrating the configuration of a photosensitive recording medium cartridge;

FIG. 4 is an external perspective view illustrating a hologram recording device applied to the photosensitive recording medium cartridge;

FIGS. 5A, 5B and 5C each are a partial sectional view illustrating how the various parts act when the photosensitive recording medium cartridge is inserted into the hologram recording device;

FIG. 6 is a partially cutaway exploded perspective view illustrating the configuration of a locking mechanism having a locking member having a shape different from above; and

FIGS. 7A, 7B and 7C each are a partial sectional view illustrating how the various parts act when the photosensitive recording medium cartridge having the configuration of FIG. 6 is inserted into the hologram recording device.

### DETAILED DESCRIPTION OF THE INVENTION

Embodiments of implementation of the invention will be described hereinafter in connection with the attached drawings.

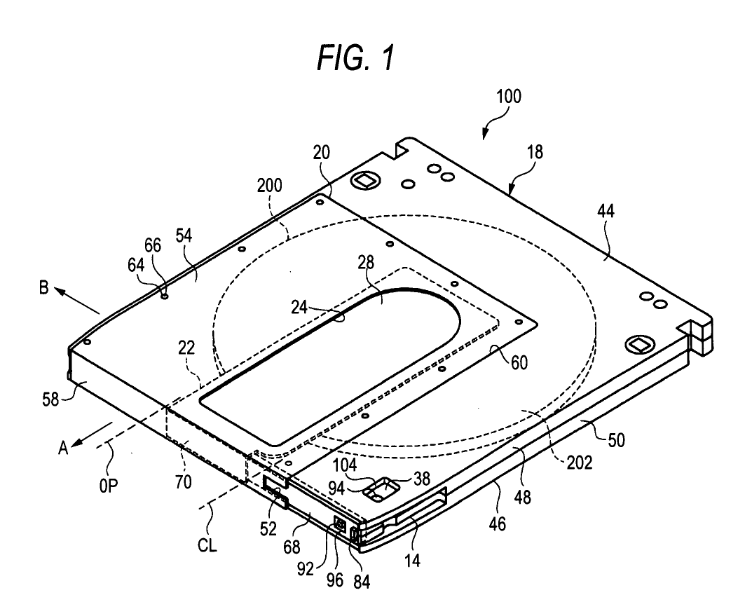

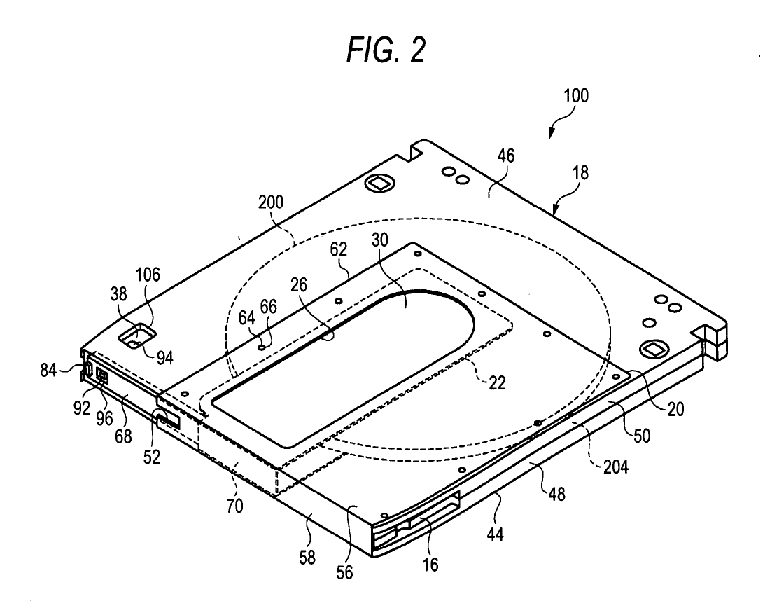

FIG. 1 is an external perspective view of a photosensitive recording medium cartridge according to an embodiment of implementation of the invention with one surface thereof upside. FIG. 2 is an external perspective view of the photosensitive recording medium cartridge of FIG. 1 with upper surface downside.

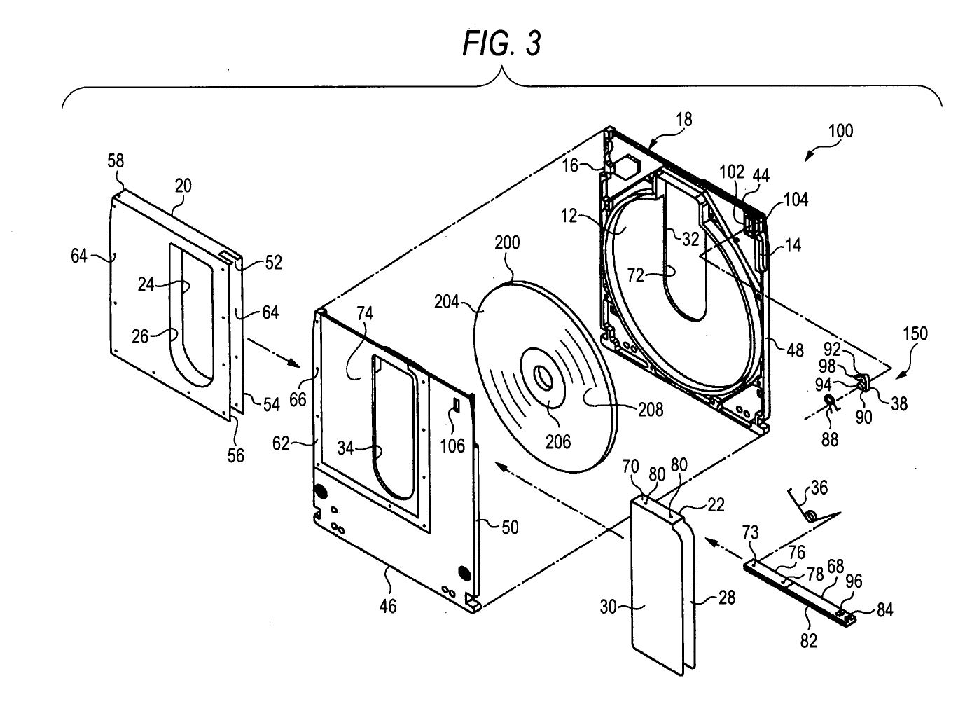

In these figures, a photosensitive recording medium cartridge 100 has a disc-shaped hologram recording medium 200 rotatably received in a disc receiving portion 12 (see FIG. 3) provided therein.

The photosensitive recording medium cartridge 100 is inserted into a hologram recording devices or other devices which process the photosensitive recording medium cartridge 100 in the direction shown by the arrow A in FIG. 1. The photosensitive recording medium cartridge 100 has a pair of positioning grooves 14, 16 provided on the respective side surface for receiving the positioning member provided in various apparatus such as hologram recording device when the photosensitive recording medium cartridge 100 is inserted into these apparatus.

The hologram recording medium 200 is a disc-shaped hologram recording medium having a hole formed in the center thereof and a hologram recording layer provided on the both surfaces thereof. The hologram recording layers each receive laser beam having a wavelength range of from 532 nm (green) to 405 nm (blue) to make multi-layer recording of data as an interference band of laser beam, The hologram recording medium 200 may be provided with a reinforcement in the hole portion thereof. The photosensitive recording medium cartridge 100 is set in the hologram recording device with either A surface 202 or B surface 204 upside to make recording on the both recording surfaces of the hologram recording medium 200.

The photosensitive recording medium cartridge 100 comprises a cartridge main body 18 having a disc receiving portion 12 provided therein, a light-shielding plate 20 attached covering the outer side of the cartridge main body 18 and a shutter 22 incorporated interposed between the cartridge main body 18 and the light-shielding plate 20. The light-shielding plate 20 has substantially rectangular external opening portions 24, 26 formed on the upper and lower surfaces thereof, respectively. The external opening portions 24, 26 are closed by a first shutter plate 28 and a second shutter plate 30 provided in the shutter 22, respectively, when the shutter 22 is in the closed position CL.

When the shutter 22 moves in the direction shown by the arrow B in FIG. 1 to the opened position OP, internal opening portions 32, 34 (see FIG. 3) having a shape analogous to that of the external opening portions 24, 26 provided in the cartridge main body 18 are opened opposed to the external opening portions 24, 26, respectively. In this arrangement, the central area 206 (see FIG. 3) and the recording surfaces 208 of the hologram recording media 200 received in the disc receiving portion 12 are exposed to the exterior.

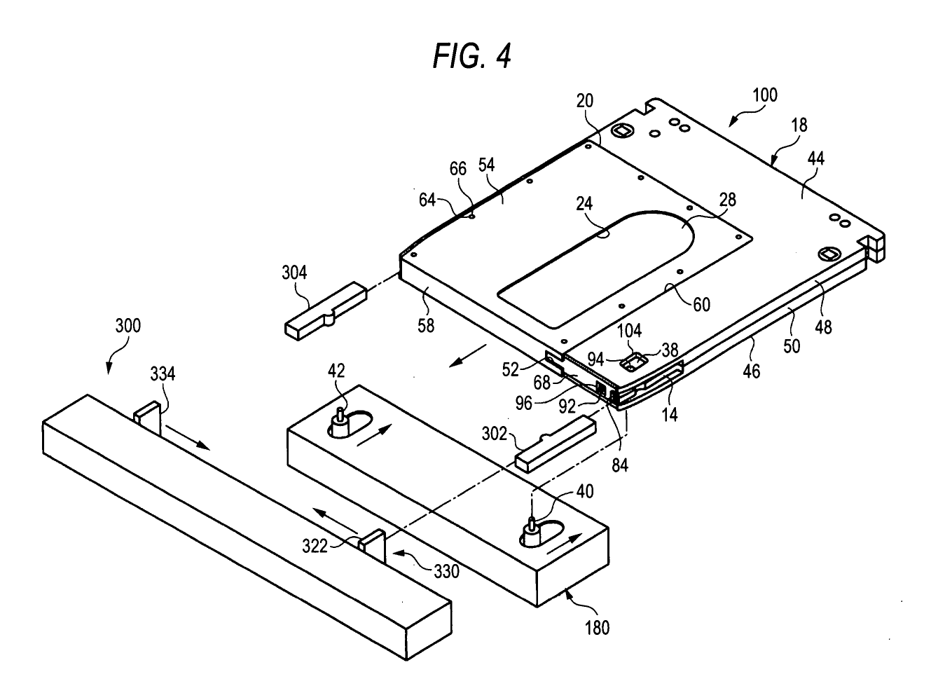

The shutter 22 is kept energized in the closing direction by a shutter spring 36 (see FIG. 3) incorporated in the cartridge 100 and is locked at the closed position CL by a locking mechanism 150 (see FIG. 3) The release of the locking mechanism 150 is made by inserting one of engagement pins 40, 42 provided in the delocking mechanism 180 (see FIG. 4) into a locking member 38 (see FIG. 3) provided in the locking mechanism 150, and then sliding the engagement pin 40 or 42. In this arrangement, the shutter 22 cannot be carelessly opened because the locking mechanism 150 can never be released unless this operation is made.

FIG. 3 is an exploded perspective view illustrating the configuration of the photosensitive recording medium cartridge 100.

As shown in FIG. 3, the cartridge main body 18 is mainly composed of a sheet-shaped first shell 44, a second shell 46 connected to the first shell 44 and a locking mechanism 150 incorporated interposed between the first shell 44 and the second shell 46 for locking the shutter 22.

In order to prepare the first shell 44 and the second shell 46, the same or analogous thermoplastic plastic having a light-shielding material and a lubricant incorporated therein is injection-molded into a sheet.

The first shell 44 has a pair of first shell side raised light-shielding walls (not shown) provided on the inner surface thereof having a greater diameter than the outer diameter of the hologram recording medium 200. The first shell 44 has a first shell side raised peripheral rail 48 provided over the entire edge thereof and an interior opening portion 32 as a first opening portion for exposing the central area 206 and the recording surface 208 of A surface 202 of the hologram recording medium 200 to the exterior.

The second shell 46 has a second shell side raised light-shielding wall (not shown) provided on the inner surface thereof having a greater diameter than the outer diameter of the hologram recording medium 200. The second shell side light-shielding wall is inserted into the pair of first shell side light-shielding walls. The second shell 46 has a second shell side raised peripheral rail 50 provided over the entire edge thereof and an interior opening portion 34 as a first opening portion for exposing the central area 206 and the recording surface 208 of B surface 204 of the hologram recording medium 200 to the exterior.

The hologram recording medium 200 is placed on the upper side of the second shell side light-shielding wall of the second shell 46. By then superposing the first shell 44 on the upper side of the second shell 46, the second shell side light-shielding wall is incorporated interposed between the pair of first shell side light-shielding walls and the forward end of the second shell side light-shielding wall comes in contact with the inner surface of the first shell 44. In this arrangement, the hologram recording medium 200 is received in the disc receiving portion 12 having a labyrinth light-shielding structure formed by these light-shielding walls. Accordingly, light or dust, if any entering through the mating surface of the peripheral raised portions 48, 50 of the first shell 44 and the second shell 46, respectively, with each other, cannot enter into the interior of the disc receiving portion 12.

Further, since the forward end of the second shell side light-shielding wall of the second shell 46 is supersonically welded to the inner surface of the first shell 44, the first shell 44 and the second shell 46 are firmly connected to each other, making it possible to prevent the formation of a clearance in the mating surface of the shells 44, 46, Supersonic welding is subject to scattering of plastic powder. However, since the first shell side light-shielding wall on the periphery of the first shell 44 and the second shell side light-shielding wall of the second shell 46 are supersonically welded to each other, the scattering of plastic powder can be minimized, making it possible to prevent the staining of the hologram recording medium 200.

When the connection of the first shell 44 and the second shell 46 to each other is effected after the incorporation of the shutter 22 and the locking mechanism 150 in the cartridge main body 18, the parts constituting the shutter 22 or the locking mechanism 150 can be also welded. In order to prevent this trouble, the material constituting the shutter 22 and the locking mechanism 150 is preferably a plastic of kind different from that of the material of the first shell 44 and the second shell 46.

As the material of the light-shielding plate 20 there may be used a material having a light weight which can be provided with light-shielding properties, corrosion resistance, decoratability and workability such as aluminum alloy. The light-shielding plate 20 may be formed by a plastic. However, in order to assure its light-shielding properties and slipperiness of the shutter 22, a plastic having a light-shielding material and a lubricant incorporated therein is preferably used. The light-shielding plate 20 has external opening portions 24, 26 formed in a thin aluminum alloy sheet and a notch 52 for giving a range within which the shutter 22 moves. The light-shielding plate 20 is formed by bending a thin aluminum alloy sheet in such an arrangement that the resulting section is substantially U-shaped. In this arrangement, the light-shielding plate 20 has a first sheet portion 54 having an external opening portion 24 formed therein, a second sheet portion 56 having an external opening portion 26 formed therein and a third sheet portion 58 connecting between the first sheet portion 54 and the second sheet portion 56. The third sheet portion 58 has the notch 52 formed therein.

The light-shielding plate 20 is mounted on the cartridge main body 18 in such an arrangement that the cartridge main body 18 is interposed between the first sheet portion 54 and the second sheet portion 56 and is covered by the third sheet portion 58 at the forward end thereof in the inserting direction. The first shell 44 and the second shell 46 have light-shielding plate mounting surfaces 60, 62 formed on the outer surface thereof, respectively, offset inside to a depth of not smaller than the thickness of the light-shielding plate 20. In this arrangement, the outer surface of the light-shielding plate 20 mounted on the cartridge main body 18 cannot protrude from the surface of the photosensitive recording medium cartridge 100.

The light-shielding plate 20 has a plurality of small holes 64 formed in the external edge of the first sheet portion 54 and the second sheet portion 56 at substantially equal intervals. Further, the light-shielding plate mounting surfaces 60, 62 of the first shell 44 and the second shell 46 have a plurality of pins 66 having a length greater than the thickness of the light-shielding plate 20 formed therein opposed to the holes 64 in the light-shielding plate 20. In this arrangement, the light-shielding plate 20 is fitted on the outer side of the cartridge main body 18. In this arrangement, the pins 66 in the first shell 44 and the second shell 46 extend through the holes 64 beyond the surface of the light-shielding plate 20. The forward end of the pins 66 are thermally crushed so that the light-shielding plate 20 is undetachably fixed to the cartridge main body 18. The fixing of the light-shielding plate 20 to the cartridge main body 18 can be carried out by the use of an adhesive or double-sided adhesive tape, screwing or like methods besides welding. In the case where the light-shielding plate 20 is formed by a plastic, various welding means can be used.

The shutter 22 is formed by bending a thin sheet having light-shielding properties in such an arrangement that a substantially U shape is formed. The shutter 22 has a slender sheet-shaped sliding member 68 incorporated therein. The shutter 22 is formed by, e.g., an aluminum alloy for the same reason as that of the light-shielding plate 20. The shutter 22, too, may be formed by a plastic. However, in this case, too, a plastic having a light-shielding material and a lubricant incorporated therein is preferably used to assure desired light-shielding properties and slipperiness. The sliding member 68 is formed by a plastic having a light-shielding material and a lubricant incorporated therein.

The shutter 22 comprises a first shutter plate 28 disposed interposed between the outer surface of the first shell 44 and the first sheet portion 54 of the light-shielding plate 20, a second shutter plate 30 disposed interposed between the outer surface of the second shell 46 and the second sheet portion 56 of the light-shielding plate 20 and a connecting portion 70 connecting between the first shutter plate 28 and the second shutter plate 30 on which connection portion 70 the sliding member 68 is mounted. The first shell 44 and the second shell 46 have shutter sliding surfaces 72, 74 formed on the outer surface thereof inside the light-shielding plate mounting surfaces 60, 62, respectively, offset inside to a depth of not smaller than the thickness of the shutter 22. In this arrangement, the shutter 22 moves smoothly through the gap between the cartridge main body 18 and the light-shielding plate 20, making it possible to prevent the generation of swarf due to movement. The shutter sliding surfaces 72, 74 each may be subjected to roughening to cause the diffusion of incident light beam. Similarly, the inner surface of the light-shielding plate 20 and the inner surface and the outer surface of the shutter 22 may be roughened.

The sliding member 68 is slidably incorporated interposed between the first shell 44 and the second shell 46 in such an arrangement that the upper side thereof is exposed at the forward end in the sliding direction of the cartridge main body 18. The sliding member 68 has a mounting surface 76 formed on the upper end thereof which is connected to the inner surface of the connecting portion 70 of the shutter 22. The mounting surface 76 has pins 78 formed integrally raised therefrom in a number of two or like numbers. These pins 78 are inserted into the two holes 80 provided in the connecting portion 70 of the shutter 22, and then thermally crushed at the forward end thereof so that the sliding member 68 is fixed to the shutter 22. The fixing of the sliding member 68 to the shutter 22, too, may be carried out by the use of an adhesive or double-sided adhesive tape or by screwing. In the case where the shutter 22 is formed by a plastic, various welding means may be used.

The sliding member 68 has a groove 82 formed on the side surfaces thereof along the longitudinal direction. The grooves 82 receive a raised portion (not shown) provided on the inner surface of the forward end of the first shell 44 and the second shell 46 in the inserting direction A so that the sliding member 68 can be slidably supported without slipping from the cartridge main body 18.

The sliding member 68 has a raised portion 84 for operation formed integrally raised therefrom on the other upper end thereof which is operated during the opening of the shutter 22. The raised portion 84 is provided in such an arrangement that the sliding member 68 extends in the shutter closing direction with respect to the shutter 22. Accordingly, the raised portion 84 is not disposed behind the third sheet portion 58 of the light-shielding plate 20 and thus is exposed to the exterior. The notch 52 formed in the third sheet portion 58 of the light-shielding plate 20 is provided to avoid interference with the raised portion 84 when the shutter 22 moves toward the opened position OP.

The shutter 22 is energized in the closing direction by a shutter energizing spring 36. The shutter energizing spring 36 is a torsion coil spring, for example. The shutter energizing spring 36 is engaged with the sliding member 68 and the inner surface of the first shell 44 at the respective end thereof.

The locking mechanism 150 is composed of a locking member 38 for locking the shutter 22 at the closed position CL and a locking spring 88.

The locking member 38 has a rectangular base portion 90 and a substantially triangular nail portion 92 formed integrally on the forward end of the base portion 90. The base portion 90 has a through hole-like operating hole 94 formed in the center thereof. The nail portion 92 has a slope 98 formed on the side thereof for guiding the engagement with a locking member inserting hole 96 formed in the sliding member 96.

When the base portion 90 is inserted in a guide frame 102 formed in the inner surface of the first shell 44, it is slidably supported in the direction perpendicular to the sliding member 68. The locking spring 88 is engaged with the base portion 90 and the first shell 44 at the respective end thereof. In this arrangement, the locking member 38 is kept energized in the direction of collision to the sliding member 68 by the rebound of the locking spring 88. The operating hole 94 in the base portion 90 is disposed opposed to a first shell side guide oval hole 104 formed extending through the first shell 44 and a second shell side guide oval hole 106 formed extending through the second shell 46.

FIG. 4 is an external perspective view illustrating a hologram recording device 300 applied to the photosensitive recording medium cartridge 100.

As shown in FIG. 4, the hologram recording device 300 comprises a pair of positioning members 302, 304, a delocking mechanism 180 for causing the licking member 38 to operate and a shutter sliding mechanism 330 for causing the shutter 22 to slide from the closed position CL to the opened position OP.

When the photosensitive recording medium cartridge 100 is inserted into the device, the pair of positioning members 302, 304 engage with positioning grooves 14, 16, respectively, to position the photosensitive recording medium cartridge 100 in the inserting direction and the direction perpendicular to the inserting direction.

The delocking mechanism 180 comprises a pair of engaging pins 40, 42 inserted into the operating hole 94 in the locking member 38 through the first shell side guide hole 104 or the second shell side guide hole 106 in the photosensitive recording medium cartridge 100 and a sliding mechanism (not shown) for causing the engaging pins 40, 42 to slide in the direction of delocking of the locking member 38. The hologram recording medium 200 allows recording on the both surfaces thereof. In order to allow operation also when the photosensitive recording medium cartridge 100 is inserted into the device upside down, the device is arranged such that one of the pair of engaging pins 40, 42 which is unnecessary in this case draws back in the sliding mechanism.

The shutter sliding mechanism 330 comprises an operating tag 332 in contact with the raised portion 84 of the sliding member 68 and a sliding mechanism (not shown) for causing the operating tag 332 to slide in the direction of sliding of the shutter 22. The shutter sliding mechanism 330 comprises another operating tag 334 in preparation for the inverted insertion of the photosensitive recording medium cartridge 100 similarly to the delocking mechanism 180.

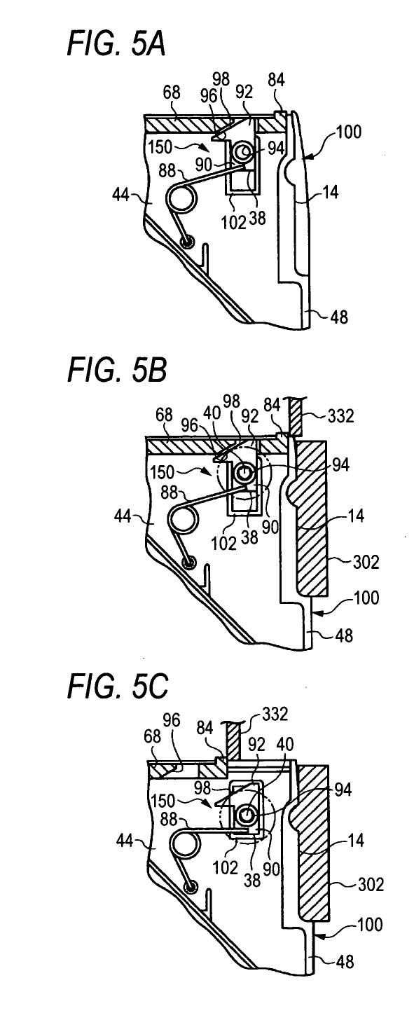

FIGS. 5A, 5B and 5C each are a partial sectional view illustrating how the various parts act when the photosensitive recording medium cartridge 100 is inserted into the hologram recording device 300.

As shown in FIG. 5A, the locking member 38 is kept energized toward the sliding member 68 by the locking spring 88 before the insertion of the photosensitive recording medium cartridge 100 into the hologram recording device 300. In this state, the nail portion 92 of the locking member 38 is disposed in a locking member inserting hole 96 in the sliding member 68 so that the sliding member 68 is unmovably retained by the locking member 38. Since the sliding member 68 is unmovable, the shutter 22 keeps closing the external opening portions 24, 26 and the internal opening portions 32, 34.

As shown in FIG. 5B, when the photosensitive recording medium cartridge 100 is inserted into the hologram recording device 300, the positioning members 302, 304 are inserted into the positioning grooves 14, 16, respectively. Subsequently, the engaging pin 40 of the delocking mechanism 180 is inserted into the operating hole 94 of the locking member 38 through the second shell side guide hole 106 of the second shell 46 and the operating tag 332 of the shutter sliding mechanism 330 is disposed outside the raised portion 84 of the sliding member 68. In this state, the nail portion 92 of the locking member 38 is kept disposed in the locking member inserting hole 96 of the sliding member 68. Accordingly, the sliding member 68 is kept unmovable by the locking member 38.

As shown in FIG. 5C, the operation shown in FIG. 5B is followed by the sliding of the engaging pin 40 of the delocking mechanism 180 in the delocking direction. Accordingly, the locking member 38 slides against the locking spring 88 in the direction away from the sliding member 68. Subsequently, the operating tag 332 of the shutter sliding mechanism 330 presses the raised portion 84 of the sliding member 68 in the direction of shutter opening, i.e., leftward as viewed on FIG. 5C. Accordingly, the shutter 22 moves to the opened position OP to pen the external opening portions 24, 26 and the internal opening portions 32, 34.

Thus, the photosensitive recording medium cartridge 100 forms a simple structure because the locking mechanism 150 is composed of only the locking member 38. Further, the locking mechanism 150 cannot be delocked unless the locking member 38 is caused to slide. In this arrangement, careless opening of the shutter 22 can be effectively prevented.

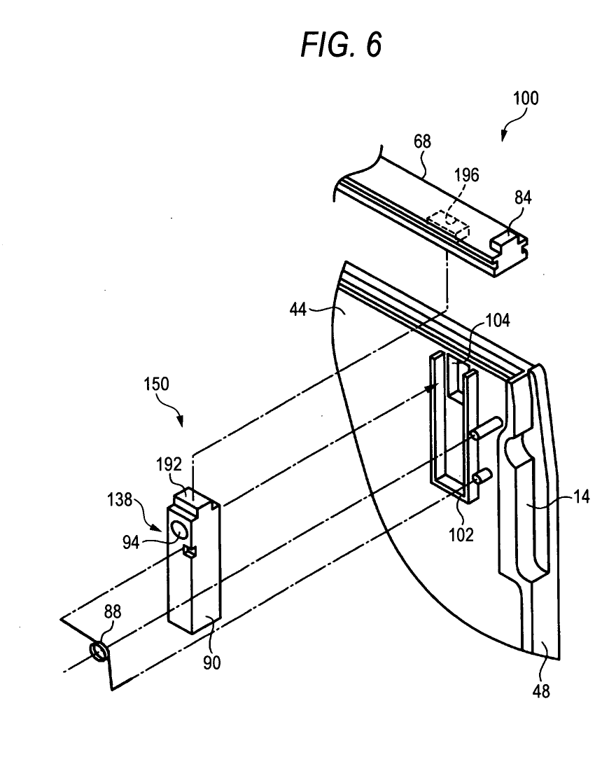

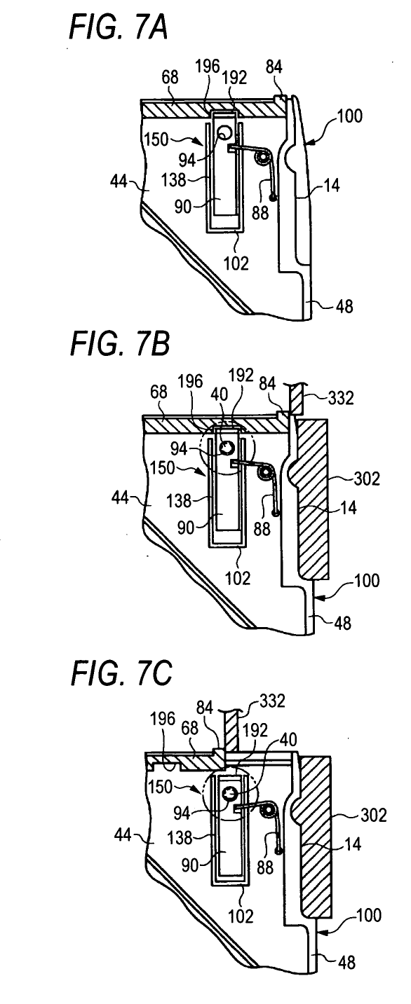

FIG. 6 is a partially cutaway exploded perspective view illustrating the configuration of a locking mechanism having a locking member having a shape different from that of FIG. 5. FIGS. 7A, 7B and 7C each are a partial sectional view illustrating how the various parts act when the photosensitive recording medium cartridge 100 having the configuration of FIG. 6 is inserted into the hologram recording device 300. In the present configuration, the members having the same configuration and action as that of those already described in the aforementioned embodiment are given the same or similar reference numerals in the drawing to simplify description.

The locking member 138 in the present configuration has a rectangular nail portion 192 formed at the forward end thereof. The sliding member 68 has a locking member inserting recessed portion 196 formed therein.

As shown in FIG. 7A, the locking member 138 is kept energized toward the sliding member 68 by the locking spring 88 before the insertion of the photosensitive recording medium cartridge 100 into the hologram recording device 300. In this state, the nail portion 192 of the locking member 138 is disposed in the locking member inserting portion 196 of the sliding member 68. Accordingly, the sliding member 68 is unmovably retained by the locking member 138.

As shown in FIG. 7B, when the photosensitive recording medium cartridge 100 is inserted into the hologram recording device 300, the positioning members 302 and 304 are inserted into the positioning grooves 14 and 16, respectively. Subsequently, the engaging pin 40 of the delocking mechanism 180 is inserted into the operating hole 94 in the locking member 138 through the second shell side guide hole 106 of the second shell 46 so that the operating tag 332 of the shutter sliding mechanism 330 is disposed outside the raised portion 84 of the sliding member 68. In this state, the nail portion 192 of the locking member 138 is kept disposed in the locking member inserting portion 196 of the sliding member 68, making the sliding member 68 unmovable by the locking member 138.

As shown in FIG. 7C, the engaging pin 40 of the delocking mechanism 180 slides in the delocking direction to cause the locking member 138 to slide against the locking spring 88 in the direction away from the sliding member 68. Subsequently, the operating tag 332 of the shutter sliding mechanism 330 presses the raised portion 84 of the sliding member 68 in the shutter opening direction, i.e., leftward as viewed on FIG. 7C. Accordingly, the shutter 22 moves to the opened position OP to open the external opening portions 24, 26 and the internal opening portions 32, 34.

In the aforementioned embodiment, as the light-shielding material to be incorporated in the plastic from which the first shell 44 and the second shell 46 are formed there may be used various materials. The light-shielding material is preferably incorporated in an amount of from 0.01% to 5.00% by weight depending on the kind thereof. As the aforementioned light-shielding material there may be used, e.g., carbon black. The incorporation of carbon black makes it possible to assure desired light shielding properties and enhance physical strength. The amount of carbon black to be incorporated in the plastic is preferably from 0.01% to 2.00% by weight. When the added amount of carbon black exceeds 0.01% by weight, the effect of enhancing light-shielding properties and physical strength can be exerted. However, when the added amount of carbon black exceeds 2.00% by weight, the resulting plastic exhibits a deteriorated physical strength.

As the lubricant there may be used, e.g., a silicon-based lubricant. The incorporation of the silicone-based lubricant makes it possible to reduce the frictional resistance and hence the generation of shavings due to the movement of the shutter 22. Further, the generation of shavings due to contact of the hologram recording medium 200 with the inner wall of the cartridge main body 18 caused by impact during transportation can be eliminated. Moreover, handleability such as insertability into apparatus can be enhanced. The incorporation of lubricant in the plastic makes it possible to enhance the fluidity of the plastic and hence the workability such as kneadability and injection-modability of the plastic during formation.

The amount of the silicone-based lubricant to be incorporated in the plastic is preferably from 0.1% to 3.0% by weight. When the added amount of the silicone-based lubricant is not greater than 0.1% by weight, the resulting effect is insufficient. When the added amount of the silicone-based lubricant is not smaller than 3.0% by weight, the resulting plastic resin exhibits too good a fluidity and thus causes slippage with the screw and undergoes deterioration in workability during kneading and formation. Further, the excessive lubricant bleeds out on the surface of the product from which it is then attached to the hologram recording medium 200 or the hands of the operator, possibly causing defectives in handleability and external appearance. A copolymer silicone, if used, can cause little such defectives and thus can be incorporated in an amount of up to 5.0% by weight.

### EXAMPLE

An example of the invention will be described hereinafter.

As the thermoplastic resin to be used in the formation of the first shell 44 and the second shell 46 there may be used PC, PBT, ABS, POM, PS, PP, HDPE, PA, PET, PPS, SAN (styrene-acrylonitrile copolymer), PMMA, PC or the like. In order to prevent erroneous welding during supersonic welding, as the material constituting the first shell 44 and the second shell 46 there is preferably used a material different from that of the first shell 44 and the second shell 46 selected from the group consisting of the aforementioned thermoplastic resins.

As the material of the first shell 44 and the second shell 46 there is used a plastic which exhibits a visible light transmittance of not greater than 1.0% at a thickness of 0.2 mm. In order to obtain a necessary physical strength, the first shell 44 and the second shell 46 each are preferably formed to a thickness of from 0.2 mm to 1.6 mm. In order to obtain a plastic having the aforementioned light-shielding properties, a light-shielding material is preferably added. As the light-shielding material there may be used any of various light-shielding materials. The light-shielding material is preferably incorporated in an amount of from 0.01% to 5.00% by weight depending on the kind thereof. Proposed examples of the light-shielding material will be given below.

(1) Inorganic Compounds

A. Oxide: silica, diatomaceous earth, alumina, titanium oxide, iron oxide (black iron oxide), zinc oxide, magnesium oxide, antimony oxide, barium ferrite, strontium ferrite, beryllium oxide, pumice stone, pumice stone balloon, alumina fiber, etc.

B. Hydroxide: aluminum hydroxide, magnesium hydroxide, basic magnesium carbonate, etc.

C. Carbonate: calcium carbonate, magnesium carbonate, dolomite, dawsonite, etc.

D. Sulfate (sulfite): calcium sulfate, barium sulfate, ammonium sulfate, calcium sulfite, etc.

E: Silicate: talc, clay, mica, asbestos, glass fiber, glass balloon, glass bead, calcium silicate, montmorillonite, bentonite, etc.

F: Carbon: carbon black, graphite, carbon fiber, carbon hollow sphere, etc.

G: Others: iron powder, copper powder, aluminum powder, molybdenum sulfide, boron fiber, silicon carbide fiber, brass fiber, potassium titanate, lead titanozirconate, zinc borate, barium metaborate, calcium borate, sodium borate, aluminum paste, talc, etc.

(2) Organic Compound

Wood powder (pine, oak, sawdust, etc.), grain fiber (almond, peanut, chaff, etc.), cotton, jute, paper piece, non-wood fiber (straw, kenaf, bamboo, esparto, pagas, mulukhiyya (jew's mallow), soot, etc.), cellophane piece, nylon fiber, polypropylene fiber, starch (including modified starch, surface-treated starch), aromatic polyamide fiber, etc.

Preferred among these light-shielding materials are inorganic compounds which have no adverse effects on photographic properties and stay thermally stable and opaque even at a temperature as high as 150° C. or more, particularly preferably carbon black, titanium nitride, graphite and black ion oxide, which are relatively inert light-absorbing materials having excellent heat resistance and light-resistance.

The added amount of carbon black, if used as a light-shielding material, is preferably from 0.01% to 2.00% by weight because a plastic having well-balanced light-shielding properties and physical strength can be obtained as mentioned above.

Examples of the classification of carbon black materials include gas black, furnace black, channel black, anthracene black, acetylene black, ketjen carbon black, thermal black, lamp black, lamp soot, soot of burnt pine, animal black, and vegetable black.

Preferred examples of commercially available carbon black products include Carbon Black #20(B), #30(B), #33(B), #40(B), #41(B), #44(B), #45(B), #50, #55, #100, #600, #950, #1000, #2200, #2400, #MA8, MA11, and MA100 (produced by MITSUBISHI KASEI KOGYO KABUSHIKI KAISHA). Further examples of commercially available carbon black products include various grade products such as Denka Black (produced by DENKI KAGAKU KOGYO KABUSHIKI KAISHA), SEAST (produced by Tokai Carbon Co., Ltd.), Asahi #78 (produced by Asahi Carbon Co., Ltd.), Showa Black (produced by Showa Cabot Co., Ltd.), NITERON (produced by Nippon Steel Chemical Carbon) and Diablack (produced by Mitsubishi Chemical Corporation).

Examples of overseas carbon black products include Black Pearls 2, 46, 70, 71, 74, 80, 81 and 607, Regal 300, 330, 400, 660, 991 and SRF-S, Vulcan 3 and 6 and Sterling 10, SO, V, S, FT-FF and MT-FF (produced by Cabot Co., Ltd.).

Further examples of overseas carbon black products include United R, BB, 15, 102, 3001, 3004, 3006, 3007, 3008, 3009, 3011, 3012, XC-3016, and XC-3017 and 3020 (produced by Ashland Chemical Company). However, the invention is not limited to these products.

As the lubricant to be incorporated in the first shell 44 and the second shell 46 there may be used a silicone-based lubricant, particularly various grade dimethyl polysiloxanes. Various grade products commercially available from Dow Corning Toray Co., Ltd., Toray Silicone Co., Ltd., GE Toshiba Silicone Co., Ltd., WACKER ASAHIKASEI SILICONE Co., LTD., Shin-Etsu Chemical Co., Ltd., etc. may be used. The lubricant may be used in the form of either master batch or kneaded product. The amount of the silicone-based lubricant to be incorporated is preferably from 0.1% to 5.0% by weight because a plastic having well-balanced frictional resistance, producibility and product quality can be obtained as mentioned above.

Referring to the roughened surface provided on the first and second shells 44, 46, when the surface roughness Ra is not greater than 5 μm, the resulting light diffusing effect is insufficient. When the surface roughness Ra is not smaller than 20 μm, these shells can scratch the hologram recording medium 200 when they come in contact with the hologram recording medium 200. Therefore, the first and second shells 44, 46 each are preferably subjected to matting for surface roughness Ra of from 5 μm to 20 μm or embossing.

As the aluminum alloy to be used in the light-shielding plate 20 and the shutter 22 there is preferably used an Al—Mg alloy such as JIS Alloy Numbers 5052 and 5056. In order to further enhance the strength, JIS Alloy Numbers 5083 and 5086 are more desirable. In order to further enhance the strength, an Al—Mg—Si alloy (e.g., JIS Alloy Numbers 6063, 6061), Al—Cu alloy (e.g., JIS Alloy Numbers 2014, 2017), Al—Zn—Mg alloy (e.g., JIS Alloy Numbers 7003, 7N01, 7075, 7050) or the like may be used. From the standpoint of weight reduction and workability, the thickness of the light-shielding plate 20 and the shutter 22 each are preferably not greater than 1.0 mm, more preferably from 0.15 mm to 0.5 mm.

The light-shielding plate 20 and the shutter 22 may be formed by a plastic. As such a plastic there is preferably used, e.g., POM. Such a plastic preferably has a light-shielding material or lubricant incorporated therein similarly to the aforementioned first shell 44, etc.

From the standpoint of spring constant, durability, workability, etc., the shutter energizing spring 86 and the locking spring 88 each are preferably made of a stainless steel for austenite spring such as SUS300. The diameter of the shutter energizing spring 86 and the locking spring 88 are preferably from 0.2 mm to 0.7 mm and from 0.15 mm to 0.4 mm, respectively.

While the present example has been described with reference to the case where the fixing of the first shell 44 and the second shell 46 to each other is carried out by supersonic welding, other welding methods and fixing methods may be used. In the case where fixing is made by screwing, for example, the light-shielding structure is preferably formed also in the periphery of the threaded hole. While the present example has been described with reference to the case where the first shell 44 and the second shell 46 each are formed by a single part, they may be each formed by a plurality of parts in combination. For example, when these shells each are formed by two parts with the disc receiving portion 12 as a border, the mold can be simplified.

While the present example has been described with reference to the photosensitive recording medium cartridge 100 for receiving the hologram recording medium 200 allowing double-sided recording, the invention may be applied to a hologram recording medium allowing one side recording. In this case, the photosensitive recording medium cartridge 100 has an opening portion only on one surface thereof which is opened and closed by the shutter 22. While the present example has been described with reference to the photosensitive recording medium cartridge 100 for receiving a hologram recording medium, the invention can be applied to the case where the photosensitive recording medium cartridge 100 receives other photosensitive recording media.

The present application claims foreign priority based on Japanese Patent Application (JP 2005-289002) filed Sep. 29, 2005, the contents of which is incorporated herein by reference.

What is claimed is:

1. A recording medium cartridge comprising:
a photosensitive recording medium having a discoid shape;
a main body comprising:
a fist opening portion exposing a center and a recording surface of the photosensitive recording medium to an exterior of the main body, the main body rotatably receiving the photosensitive recording medium;
a light-shielding plate comprising:
a second opening portion opposed to the first opening portion, and exposing the center and the recording surface of the photosensitive recording medium to the exterior of the main body, the light-shielding plate being attached to the outer side of the main body;
a shutter incorporated between the main body and the light-shielding plate, having an external size greater than the first opening portion and the second opening portion, and the shutter being movable between a closed position and an opened position within the range of the light-shielding plate; and
a single locking member retaining the shutter at the closed position and allowing the shutter to open from the closed position.

2. The photosensitive recording medium cartridge as claimed in claim 1, which comprises:
a sliding member having a longitudinal portion connected to the shutter, the longitudinal portion extending close to the edge portion of the main body along the moving direction of the shutter, the sliding member being engaged with the locking member disposed apart from the opening portion at the closed position of the shutter, and being released from the locking member by opening operation.

3. The recording medium cartridge as claimed in claim 1, wherein the main body has been subjected to one of matting and embossing on an inner surface of the main body opposed to the photosensitive recording medium and an outer surface of the main body opposed to the shutter so that the inner surface and the outer surface of the main body have a surface roughness of from 5 μm to 20 μm.

4. The recording medium cartridge as claimed in claim 1, wherein the main body comprises:
a first shell having a sheet shape; and
a second shell welded to the first shell in an arrangement superposed on the first shell,
the first shell and the second shell comprise same or analogous thermoplastic plastic each other, and
other parts including the shutter comprise a material different from the thermoplastic plastic of the first shell and the second shell.

5. The recording medium cartridge as claimed in claim 1, wherein the first shell, the second shell and the shutter comprise a plastic containing a light-shielding material of 0.01% to 5.00% by weight.

6. The recording medium cartridge as claimed in claim 1, wherein the first shell, the second shell and the shutter comprise a plastic containing a carbon black of 0.01% to 2.00% by weight.

7. The recording medium cartridge as claimed in claim 1, wherein the first shell, the second shell and the shutter comprise a plastic containing a silicone-based lubricant of 0.1% to 5.0% by weight.

8. The recording medium cartridge as claimed in claim 1, wherein the photosensitive recording medium is a hologram recording medium.
